(19) United States
(12) Patent Application Publication
(10) Pub. No.: US 2026/0259961 A1
(43) Pub. Date: Sep. 3, 2026

(54) CLOUD-BASED SYSTEM AND METHOD FOR GENERATING AND UTILIZING DIGITAL MEDIA USING ARTIFICIAL INTELLIGENCE

(71) Applicant: M.I., INC., Seattle, WA (US)

(72) Inventors: Chong Ng, Seattle, WA (US); Ngoc Anh Nguyen, Ha Noi (VN)

(21) Appl. No.: 19/067,129

(22) Filed: Feb. 28, 2025

(51) Int. Cl. G06F 21/10; G06F 21/64

(52) U.S. Cl. CPC G06F 21/1014; G06F 21/107; G06F 21/64

(57) ABSTRACT

Integrated system and method for managing, monetizing, and moderating within an e-commerce platform AI-generated digital media content that leverages an individual's likeness, including voice, image, and textual works are provided. By allowing owners to register their identity and configure usage parameters, the system and method ensures that all AI-based creations prepared or posted in the platform, whether for single-use or large-scale purposes, are properly authorized. Flexible smart contract are used to allow owners to set precise licensing terms, define acceptable content parameters, and automate fee structures for on-demand or bulk generation scenarios. Additionally, robust moderation tools enabling owners to either manually review every request for AI-based generation of digital media items utilizing the owner's likeness or work or rely on automated systems are provided. These moderation controls adapt seamlessly to high-volume use, ensuring that owners retain control over the content produced in their likeness and work without compromising scalability.

### FIELD

This application relates in general to dentistry, and in particular, to a cloud-based system and method for generating and utilizing digital media using artificial intelligence.

### BACKGROUND

E-commerce and other websites that rely on use of digital media currently face multiple challenges. One such challenge is the violation of a person's rights in their likeness and work through the use of generative artificial intelligence (AI). Generative AI has reached a state of maturity when individuals can produce high-fidelity voice, image, and text content using publicly available tools and models. This technological evolution not only streamlines creative workflows, but also presents significant opportunities to expand ways in which people create, share, and monetize digital media content. Nevertheless, the same ease of access that empowers legitimate creators also enables bad actors to “clone” another person's likeness, including voice, image, and writing style, without the individual's knowledge or consent.

Consequently, unauthorized usage of personal identity in AI models has become a growing concern, creating doubt as to whether a particular digital media item associated with a person's likeness, such as an image (or a collection of images such as in a video), audio, or textual file has been lawfully produced and endorsed by the owner of the rights to that likeness, or is an unauthorized derivation. This doubt in turn hinders monetization of lawfully generated digital media and allows propagation of media made with violation of the true owner's rights. In addition, such doubt can hinder the use of digital media content on a website due to fear of legal liability when unauthorized content is posted by bad actors.

Attempts to address this hindrance to propagation of lawful AI-generated digital media creations have fallen short. While certain platforms address limited aspects of AI-driven content generation or provide rudimentary methods for user verification, none offer a comprehensive solution that seamlessly links the genuine content to the rightful owner and transparently communicates that authenticity to others. Moreover, existing approaches are not easily scalable and thus do not adequately accommodate scenarios when the request volume is substantial, determining an identity owner to manually review every generation request.

Further, even beyond the technical complexities of managing personal identity rights, many e-commerce and influencer-driven marketplaces impose restrictive policies that accept only a small number of influencers based on strict following thresholds. These platforms often lack fluid commission structures, failing to assign fees or payouts in an automated, performance-based manner. As a result, influencers and sellers are frequently required to negotiate commissions individually, discouraging new influencers from entering the market and limiting their ability to set competitive pricing for their audiences.

Accordingly, there is a need for a mechanism that permits individuals to offer their identity for AI media content generation, supports large-scale requests for content generation, and provides moderation tools to control how that identity is used in generation of digital media content. There is a further need for a way to establishing an inclusive e-commerce marketplace that allow for dynamic influencer commission structures.

### SUMMARY

Integrated system and method for managing, monetizing, and moderating within an e-commerce platform AI-generated digital media content that leverages an individual's likeness, including voice, image, and textual identity are provided. By allowing owners to register their identity and configure usage parameters, the system and method ensures that all AI-based creations prepared or posted in the platform, whether for single-use or large-scale purposes, are properly authorized. Flexible smart contract are used to allow owners to set precise licensing terms, define acceptable content parameters, and automate fee structures for on-demand or bulk generation scenarios. This configuration streamlines delivery of AI-generated digital media content at scale while simultaneously preserving each owner's right to control the quality and type of output produced under their name or likeness. Additionally, the system and method allow robust moderation tools enabling owners to either manually review every request for AI-based generation of digital media items utilizing the owner's likeness or work or rely on automated systems to reject non-compliant generation attempts. These moderation controls adapt seamlessly to high-volume use, ensuring that owners retain control over the content produced in their likeness and work without compromising scalability. In doing so, the system and method provide a secure ecosystem that balances ease of access to AI-generative capabilities with the necessity for ownership validation, fair compensation, and consistent quality assurance.

Further, the provided system and method also addresses the evolving demands of influencer-driven commerce. Unlike conventional marketplaces that impose restrictive entry conditions and fixed commission rates, the platform according to the provided system and method utilizes a dynamic assignment of commission based on an influencer's performance metrics, reach, and sales levels. This inclusive structure allows influencers of any size to join the marketplace, where they can promote AI-generated or physical products, set their own incentives, and transparently receive commissions. By integrating identity licensing and influencer marketing within a unified framework, the system and method open new opportunities for creators to monetize their personal brand and for influencers to expand their audience engagement.

In one embodiment, a cloud-based system and method for generating and utilizing media using artificial intelligence is provided. The system includes a platform in a cloud-computing environment and including a plurality of layers, each of the layers implemented by one or more servers, the layers including: a presentation layer configured to receive from a computing device of a user over an Internetwork training data for generating media; an application layer configured to: train an artificial intelligence model using the training data and to generate one or digital media items using the trained model; generate a non-fungible token (NFT); generate a file pattern for each of the generated digital media items; store in the file pattern associated with each of the generated digital media items in a database comprised in the platform; use one or more of the file patterns for comparison of one or more further digital media items to the digital media items associated with those signatures; and take an action on the one or more further digital media items based on the comparison.

Still other embodiments will become readily apparent to those skilled in the art from the following detailed description, wherein are described embodiments by way of illustrating the best mode contemplated. As will be realized, other and different embodiments are possible and the embodiments' several details are capable of modifications in various obvious respects, all without departing from their spirit and the scope. Accordingly, the drawings and detailed description are to be regarded as illustrative in nature and not as restrictive.

### BRIEF DESCRIPTION OF THE DRAWING

FIG. 1 is a block diagram showing a system for generating and utilizing digital media using artificial intelligence in accordance with one embodiment.

FIG. 2 is a flow diagram showing a method for generating and utilizing digital media using artificial intelligence in accordance with one embodiment.

FIG. 3 is a diagram showing a routine for logging a user into the platform for use in the method of FIG. 2 in accordance with one embodiment.

FIG. 4 is a flow diagram showing a routine for generating new DMI for use in the method of FIG. 2 in accordance with one embodiment.

FIG. 5 is a flow diagram showing a routine for monetizing AI model for use in the method 20 of FIG. 2 in accordance with one embodiment.

FIG. 6 is a flow diagram showing a routine for verifying authenticity of a DMI for use in the method of FIG. 2 in accordance with one embodiment.

FIG. 7 is a flow diagram showing a subroutine for public DMI verification for use in the routine of FIG. 6 in accordance with one embodiment.

FIG. 8 is a flow diagram showing a subroutine for private DMI verification for use in the routine of FIG. 6 in accordance with one embodiment.

FIG. 9 is a flow diagram showing a routine for performing product price regulation based on influencer input for use in the method of FIG. 2 in accordance with one embodiment.

### DETAILED DESCRIPTION

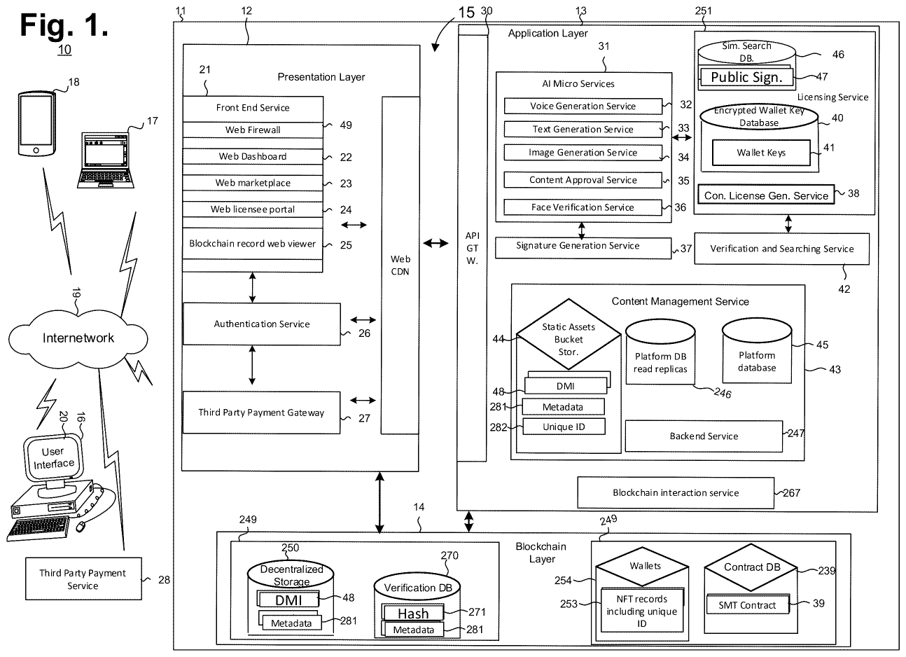

The system and method described below provide is a need for an integrated e-commerce marketplace platform that allows (1) individuals to safely commercialize their identity and work and control how AI models leverage their voice, image, or textual style; (2) delivers robust moderation tools to handle the full scale of content requests; and (3) dynamically calculates and assigns commissions for influencers in an inclusive e-commerce environment. The system ensures that only properly authorized use of AI-generated likeness is monetized on the platform, empowers rights holders to moderate content at scale, and establishes an equitable marketplace for creators, influencers, and buyers alike. FIG. 1 is a block diagram showing a system 10 for generating and utilizing digital media using artificial intelligence in accordance with one embodiment. The system includes a cloud-computing environment 11, such as an environment that is implemented by Microsoft Azure®, provided by Microsoft Corporation of Redmond, Washington, though other cloud-computing environments 11 are possible. Inside the cloud-computing environment 11 are a implemented a plurality of interconnected layers 12-14 together making up an e-commerce marketplace platform 15: a presentation layer 12, an application layer 12, and a blockchain layer 14. The layers 12-14 are implemented by a plurality of databases and servers, which can be physical servers or virtual machines. As further described below, the presentation layer 12 performs interactions with the users of the platform 15; the application layer does backend processing based on user input through the presentation layer 12; and the blockchain layer securely stores publicly accessible results of the other layers.

The presentation layer 12 includes multiple components that are used for interaction with computing devices 16-18 of users of the system 10, such as users who want to use the platform to monetize their own likeness or textual works by producing digital media items (DMI), such as images, videos, audio files, and text via artificial intelligence provided by the platform 15; users who want to verify the authenticity of other DMI; users who want to produce DMI based on another user's likeness or work using the platform 15 in an authorized manner; as well as other users who can be sellers and buyers of particular products sold through the platforms as well as influencers advertising the products. Still other kinds of users are possible. While the computing devices 16-18 are shown as a desktop computer, a laptop computer, and a smartphone, other kinds of computing devices, including tablets and smartwatches are possible. The computing devices 16-18 interface with the presentation layer 12 via an Internetwork 19, such as the Internet or a cellular network, and display a user interface 20 through which user input provided to the presentation layer 12 is received and data received from the presentation layer 12 is presented. The user interface 20 can be implanted through a dedicated downloadable mobile application for interfacing with the platform 15 or through a web browser.

The presentation layer 12 includes a frontend service 21 that includes a web firewall 49 separating all other components of the platform 15 from components of the system 10 outside of the platform 15. The firewall 49 Protects the layer 12-14 by filtering malicious traffic and preventing attacks such as SQL injections, DDoS, and XSS. All communications with the computing devices 16-18 occur through the frontend service 21. The front end service 21 further includes a web dashboard 22. Serving as the primary interface for the users, the web dashboard 22 allows: content creators to manage their assets, track content performance, and view licensing metrics; sellers to manage their listed items, create campaigns that utilize the platform's influencers, configure campaign-specific terms such as commission rates, duration, and discounts for buyers; Influencers to manage their campaigns, track sales performance, and view assigned commission tiers and metrics; buyers to monitor purchased content and licensing agreements. The web dashboard 22 integrates performance analytics, campaign management tools, and seamless navigation between user roles.

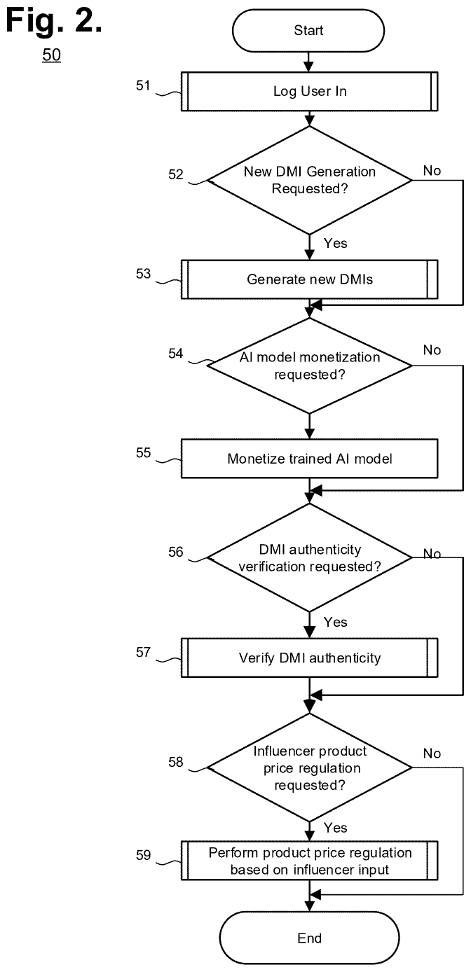

The frontend service 21 further includes a web marketplace 23 that serves as the central hub for listing, purchasing, and promoting DMI and other digital assets, as further described below beginning with reference to FIG. 2. The web marketplace 23 includes filters for buyers to search for content by type, licensing terms, or creator identity.

The frontend service 21 further includes a web license portal 24 offers buyers a dedicated portal to manage purchased licenses, including tracking usage rights, expiration dates, and payment history. In addition, the frontend service 21 includes a blockchain record web viewer 25 that provides a public-facing interface to view ownership records, licensing statuses, and associated metadata stored in the blockchain layer 14. All of the information on the blockchain layer 14 is public and therefore all users can see through the web viewer 25 any desired information stored in the blockchain layer 14, thus allowing to confirm whether DMI made by other users are authorized by the rightful content owner. In one embodiment, the front end service 21 can be a Next.js® frontend designed by Vercel Inc. of Covina, CA, though in a further embodiment, other kinds of frontend service 21 are also possible. In a further embodiment, other components of the presentation layer 11 can also be made using the Next.js® framework, though other frameworks can also be used.

The presentation layer 12 further includes an authentication service 26 that through the frontend service performs authentication of credentials (such as username and password, though other credentials are also possible) of a particular user to allow the user to log into the platform 15. The authentication service 26 supports both OAuth integration with third-party providers (e.g., Google, Facebook) and JWT (JSON Web Tokens) for secure session management. The authentication service further implements Role-Based Access Control (RBAC) to restrict actions and access based on user roles (such as Creator, Seller, or Influencer).

The presentation layer 12 further include a third party payment gateway 27, which interfaces (through the frontend service 21) with a third party payment system 28 to process transactions made by users of the platform 15. In one embodiment, the third party payment system can be Stripe® operated by Stripe, Inc. of South San Francisco, CA, though in a further embodiment, other kinds of third party payment systems 28 are possible.

The presentation layer 12 further includes a web content delivery network (CDN) 29, which is interfaced to all other components of the presentation layer 12. The CDN 29 is a geographically distributed network of proxy servers and their data centers through which interfacing with the computing devices 16-18 (and consequently to the users associated with those devices), allowing to accelerate delivery of data to the users by using the proxy servers geographically nearest to their computing device 16-18 for delivery of data. In particular, the CDN caches and serves static files (e.g., JavaScript, CSS, and images) to improve performance and reduce latency across geographic regions.

The application layer 13 manages business logic, AI processing, and interaction with blockchain and storage services, as further described below beginning with reference to FIG. 2. The layer's modular microservices architecture ensures scalability and reliability. The application layer 13 is interfaced with the presentation layer 12 via an API Gateway 30 that is part of the application layer 13 and which serves as the central access point for backend services, providing: request routing to microservices; authentication of incoming API calls using JWT tokens; and rate limiting to prevent abuse and ensure system stability. The application layer also includes AI Microservices 31, which are independent services designed to handle AI-driven tasks, including generation of new DMI 48. The newly generated DMI 48 are stored in two locations. One location is on the Decentralized Storage 250 on the blockchain layer 14, which stores only DMI 48 that are intended by their creator to be visible to the public. Another location is the Static Asset Bucket Storage 251 on the application layer 12, which stores both the public DMI 48 and the DMI 48 that are intended by their creator to be private. The AI Microservices 31 include: an AI Voice Generation Service 32 that produces high-fidelity voice content based on user input using one or more AI models (such as 11LAB model, XTTS model, though other models are possible) stored within the service 32; AI Image Generation Service 33 that generates custom images using advanced AI model (such as FLUX model, though models are possible); AI Text Generation Service 34 that creates natural language text for specific use cases using a large language AI model (LLM), such as Mistral or LLAMA, though other AI models are also possible; AI Content Approval Service 35 that applies automated moderation rules to ensure compliance with platform policies; and AI Face Verification Service 36 that validates user identity by matching facial data to registered profiles as an additional way to verify the user's identity and permissions to take action within the platform 15, as well to verify whether a particular DMI is associated with a particular user.

The platform can create two kinds of file patterns that help during search and validation of DMI. One kind of a file pattern is a signature 47 of DMI 48 is a set of unique features extracted from that DMI 48. Another kind of a file pattern is a cryptographic hash 271 of a DMI 48 that is prepared using a cryptographic algorithm (such as SHA-256, though other algorithms can also be used). The application layer 13 further includes a Signature Generation Service (SGS) 37 that generates signatures 47 of the DMI generated and verified by the platform 15, with each signature 47 being a set of unique features extracted from a DMI 48. The SGS 37 can also generate the cryptographic hash 271 of the DMI that have been set as private. The signatures 47 can be stored within a similarity search database 46 within a content licensing service 252 in the application layer. The SGS 37 is used for ensuring authenticity of AI-generated content and includes modules for: spectrogram generation that convert audio files into frequency-based visual signatures; image-perpetual hashing that produces unique hashes for image content, enabling efficient comparison and verification; and performs text-matching search and a vector search to the text to generate signatures for text.

The application layer 13 further includes a Licensing Service 37 that automates operation of the platform 15. In particular, the Licensing Service 37 includes a content license generation service 38 that creates and enforces licensing agreements using smart contracts 39 that are stored within a smart contract database 239 within the blockchain layer 14; and an encrypted wallet key database 40 that stores private keys 41 for securing user wallets, ensuring safe blockchain interactions. In order to access and control transactions of a blockchain wallet 254, a private key 41 associated with that wallet 254 is necessary. A wallet 254 allows a user to store and generate records 253 for an NFT (including unique identifier of the DMI making up the NFT and metadata 281 associated with the DMI) and make transactions involving the NFTs, such as transferring an NFT to another user. A wallet stores, sends, receives cryptocurrency or digital assets such as NFTs. A wallet 254 is implemented as part of the blockchain layer 14 and a private key 41 is necessary to make transactions within the wallet. In particular, when an NFT is minted the wallet creates a transaction with the smart contract 39, and the smart contract 39 records the identity of the user (the address of the wallet), the unique identifier of the NFT (that is coupled to the DMI, though other information can also be recorded).

The application layer 13 further includes a Verification and Searching Service 42 that matches and validates content against registered DMI, including through spectrogram matching (identifies similar audio files using spectrogram analysis); image searching (locating visually similar images using perceptual hashing); and text index and search (conducting linguistic and keyword-based searches for text content). The Verification and Searching Service 42 also performs authentication of DMI that the user would like to remain private against private DMIs 48 stored on the platform by creating a hash of an uploaded file and then comparing the created hash for the uploaded file to the cryptographic hashes 271 in the verification database 270 to see if an exact match exists; if there is no exact match, the authenticity is denied. By letting a user use only a hash of a file whose authenticity needs to be verified, with the platform deleting the original uploaded file, the privacy of the uploaded file is preserved.

The application layer 13 additionally includes a Content Management Service (CMS) 43 including multiple components. The components include a Static Assets Bucket Storage 44 that stores large files (such as images, audio, and other DMI 48 that have been set private by their creator as well as DMI 48 that are public) off-chain in an encrypted format while maintaining links to blockchain records in the blockchain layer 14. The DMI 48 are stored with the metadata 281 and unique identifier 282 of that DMI 48 in the Storage 44. The metadata 281 can include information about the owner and any licensor (under whose license a particular DMI was made) of a particular DMI 48 (including a mapping to a wallet address of the owner or the licensor and a user ID of that owner or licensor). The metadata 281 can further include information about when and how a particular DMI 48 was made as well as links to any social media accounts of the user who is the owner or licensor of the DMI 248. Such information hinders overwriting identity of the owner or a licensor of a particular DMI 48 in case the platform is hacked he CMS 43 further includes a Platform Database 45, which can be a PostgreSQL database stores user profiles, metadata for non-DMI files in the platform, and transactional data. One or more read replicas of the Platform 45 are stored in a separate database 246 to support high availability and scalability of the platform 15. The CMS 43 further includes a Backend Service 247 that provides essential backend logic for managing content, user data, and campaign configurations. These services ensure efficient communication between the Web Dashboard 22 and other system components.

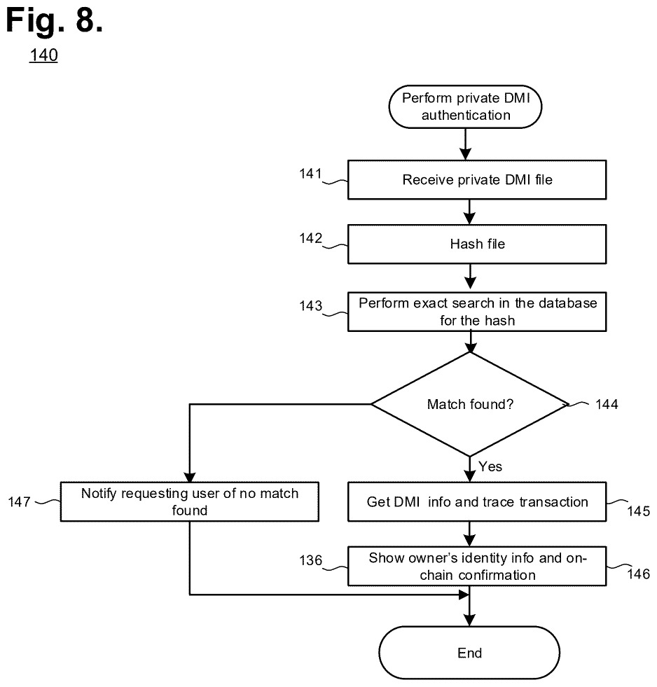

The application layer 13 further includes a Blockchain Interaction Service (BIS) 267 that acts as the intermediary between the application layer 13 and the blockchain layer 14, including handling minting of non-fungible tokens (NFTs) by combining a DMI (in case of a DMI intended to be public) or a hash 271 of a DMI (for a DMI intended to be private) with a unique identifier to make each NFT, as well as registration of AI-generated content on the blockchain layer 14. In the case of a publicly available DMI, an NFT for that DMI 48 is the DMI 48 coupled to a unique identifier and recorded on the blockchain layer 14. For a private DMI 48, an NFT 2 for that DMI is a hash 271 of the DMI 48 coupled to a unique identifier and recorded on the blockchain layer 14. The hashes 271 are stored in a verification database 270 in the blockchain layer and can be used for verification of authenticity of DMIs uploaded by a user, as further described with reference to FIG. 8. The hashes 271 are stored in association with the metadata 281 for the DMI 48 from which the hashes were derived. The BIS 247 also handles execution of smart contracts for licensing and revenue sharing; retrieval of on-chain data, including ownership and transaction history.

The blockchain layer 14 provides the foundation for recording, verifying, and managing ownership and licensing of digital content including DMI generated by the platform. This layer 14 ensures transparency and traceability. The components of the blockchain layer described below are implemented using blockchain blocks 249 (also referred to as blockchain nodes). In one embodiment, the blockchain blocks 249 can be implemented the Solana® blockchainistributed by Solana Foundation, though in a further embodiment, other types of blockchain platform can be used. One component that the blockchain layer includes is a storage 248 of smart contracts executed using the platform 15, which implements blockchain-based logic for licensing and monetization; supports exclusive and non-exclusive licensing models, usage restrictions (e.g., time-bound or geographical), and automated royalty distribution; and automatically allocates payments among creators, collaborators, and influencers based on predefined terms. Further, the blockchain layer includes blockchain blocks 249 that represents connections to Solana (or other blockchain varieties) validators for submitting and verifying transactions and enable real-time updates and synchronization between the off-chain system (the static storage bucket) and the blockchain. In the blockchain layer 14, each transaction within the blockchain ledger is cryptographically time-stamped using a verifiable sequencing mechanism, ensuring its order and authenticity regardless of the consensus mechanism used, including Proof of Work (PoW), Proof of Stake (POS), Proof of History, or any other validation method. Transactions are processed asynchronously and grouped into batches, with validators independently verifying their position in the ledger without requiring explicit references to preceding blocks. This technique eliminates the necessity for traditional block chaining via cryptographic hashes, instead leveraging an immutable, time-ordered record to establish consensus, maintain transparency, and prevent data tampering.

Other components of the layers 12-14 are also possible. The architecture of the platform 15 described above provides scalability and security features that ensure robust operation. In particular, the architecture of the microservices 31 allows for independent scaling of services based on demand (such as high-usage AI services). The platform can utilize encrypted communication, securing sensitive data transmission using encryption protocols such as AES-256 and TLS protocols. Further, the architecture allows for monitoring and logging of activity on the platform through use of tools such as Prometheus and Grafana to provide real-time performance tracking and issue detection.

The servers, databases, and other hardware supporting the platform 15 servers 13 can include one or more modules for carrying out the embodiments disclosed herein. The modules can be implemented as a computer program or procedure written as source code in a conventional programming language and is presented for execution by the central processing unit or a graphics processing unit (GPU) as object or byte code. Alternatively, the modules could also be implemented in hardware, either as integrated circuitry or burned into read-only memory components, and each of the servers can act as a specialized computer. For instance, when the modules are implemented as hardware, that particular hardware is specialized to perform the computations and communication described above and other computers cannot be used. Additionally, when the modules are burned into read-only memory components, the computer storing the read-only memory becomes specialized to perform the operations described above that other computers cannot. The various implementations of the source code and object and byte codes can be held on a computer-readable storage medium, such as a floppy disk, hard drive, digital video disk (DVD), random access memory (RAM), read-only memory (ROM) and similar storage mediums. Other types of modules and module functions are possible, as well as other physical hardware components.

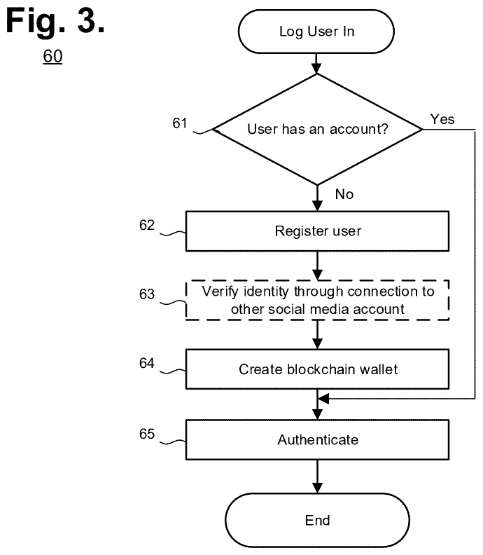

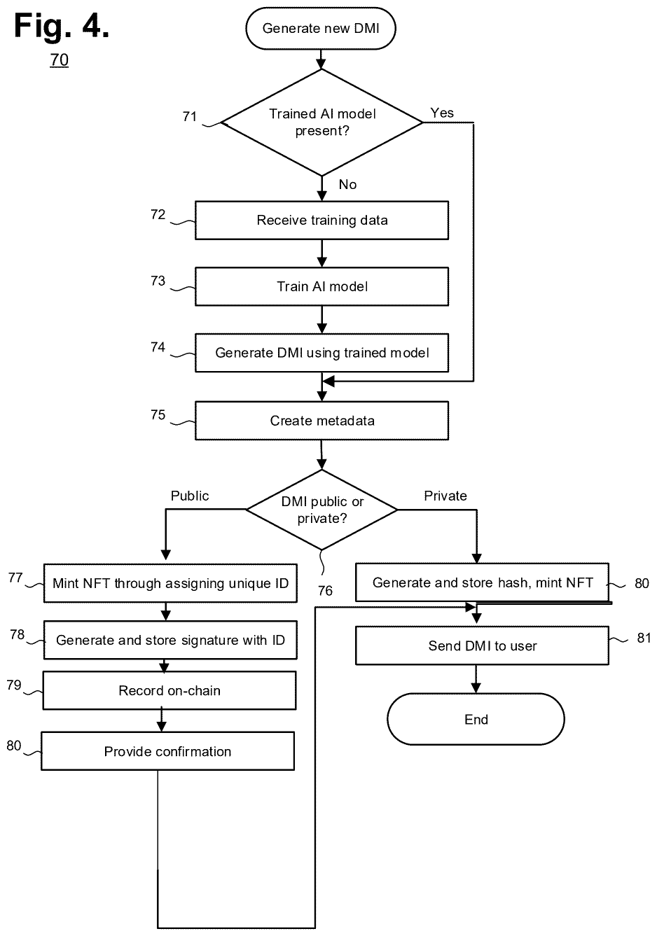

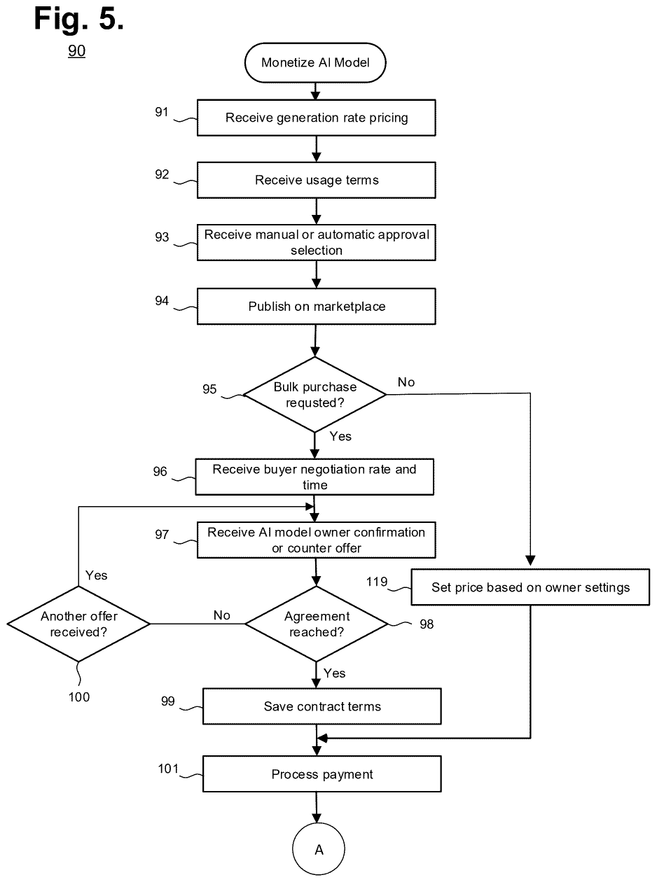

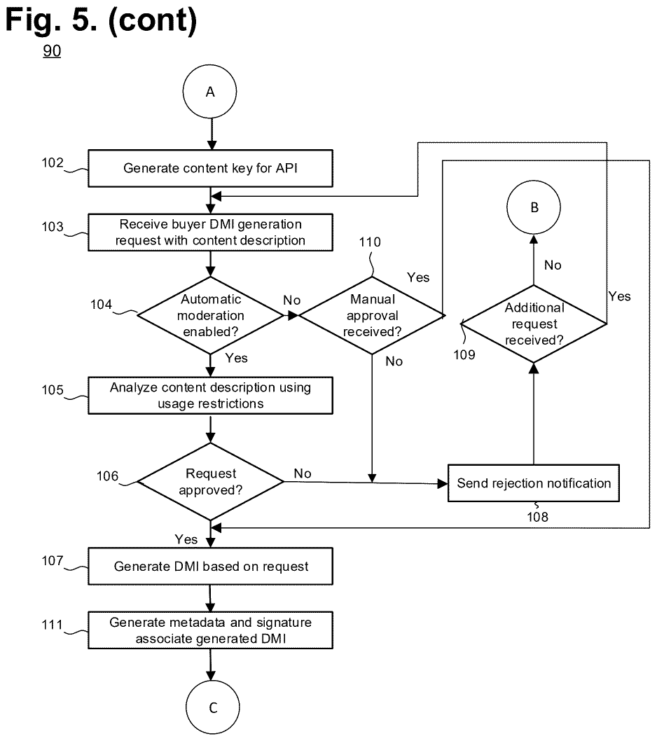

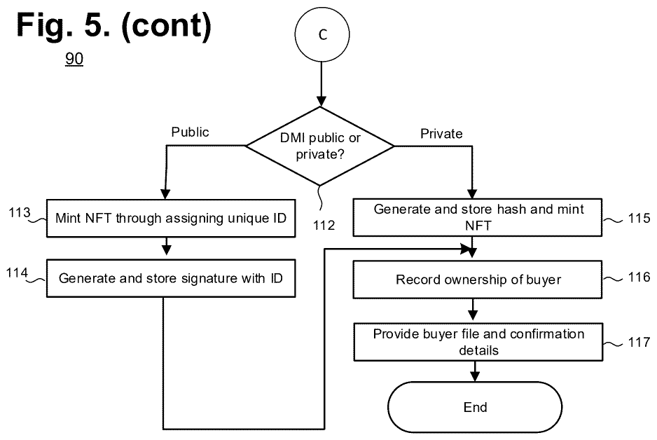

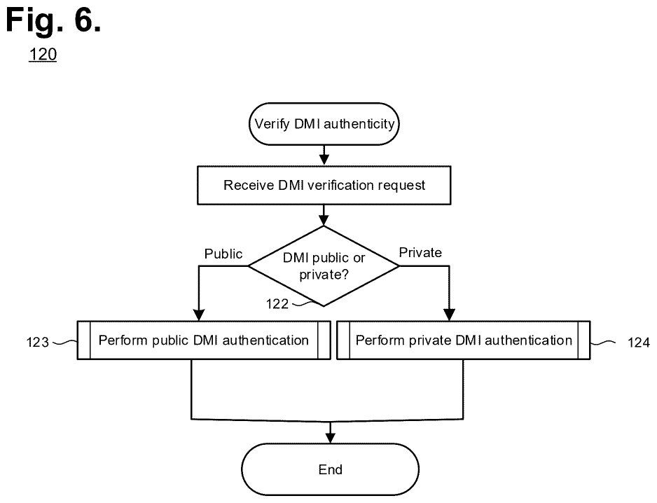

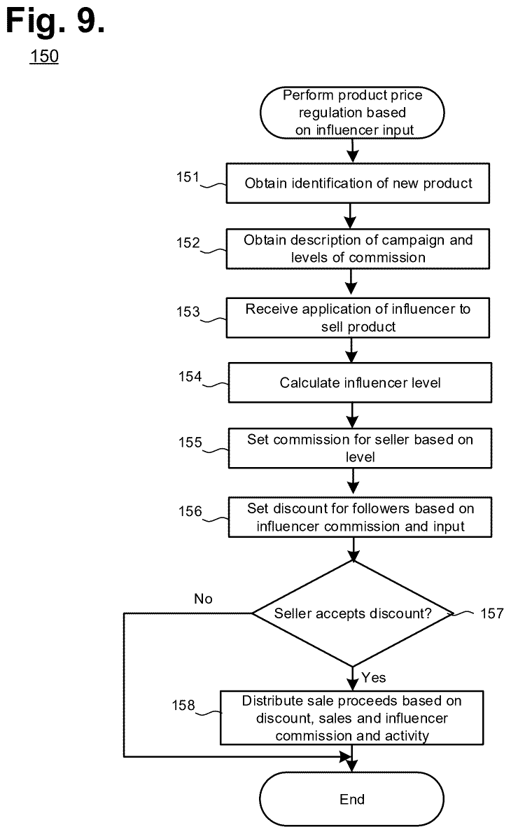

The marketplace implemented by the platform described above allows to both automate lawful generation and licensing of DMI using artificial intelligence and reduce barriers to entry influencer-marketing based sales. FIG. 2 is a flow diagram showing a method 50 for generating and utilizing digital media using artificial intelligence in accordance with one embodiment. The method 50 can be implemented using the system 10 of FIG. 1. First, a user logs into the platform, as further described below with reference to FIG. 3 (step 51). Whether the user requests generation of a new DMI based on the user's likeness or textual works is determined (step 52). If the DMI generation is requested (step 52), the DMI generation is performed, as further described below with reference to FIG. 4 (step 53). If the DMI generation is not requested (step 52), the method moves to step 54. Whether the monetization of the AI model trained on the training data of the user's likeness and textual work is requested by the user is determined (step 54). If the monetization is requested (step 54), the monetization is performed (step 55), as further described below beginning with reference to FIG. 5. If no monetization is requested (step 54), the method 50 moves to step 56. Whether determination of an authenticity of a DMI is requested by the user is determined (step 56). If the authenticity determination is requested (step 56), the authenticity determination is performed as further described below with reference to FIGS. 6-8 (step 57). If the authenticity determination is not requested (step 56), the method moves to step 58. Whether the user requests product price regulation based on influencer input is determined (step 58). If the regulation is requested (step 58), the regulation is performed as described below with reference to FIG. 9 (step 59). If the regulation is not requested (step 58), the method 50 ends.

Allowing a user to log in into the platform lets the user act in accordance with previously established privileges and contracts. FIG. 3 is a diagram showing a routine 60 for logging a user into the platform for use in the method 50 of FIG. 2 in accordance with one embodiment. Whether a user has an account with the platform is determined by the presentation layer (step 61). If the user already has an account (step 61), the user is authenticated (such as by supplying the correct name and password to the authentication service) and logged in (step 65), ending the routine 60. If the user does not have an account with the platform (step 61), the user is registered with the platform (step 62), such as providing by providing desired user name, password, first and last name, and optionally payment details (such as an account details at the third party payment service). Optionally, the user's first and last name are verified by asking the user to sign in with a social media (such as Facebook® or LinkedIn®) or email (such as Google®) account. A blockchain wallet is created for the user on the blockchain layer in the encryption wallet key database (step 64). The user is logged in in step 65 as described above (step 65), ending the routine 60.

The application layer of the platform allows a user to generate DMI and link that DMI to an NFT through training an artificial intelligence model. FIG. 4 is a flow diagram showing a routine 70 for generating new DMI for use in the method 50 of FIG. 2 in accordance with one embodiment. Whether the user requesting DMI generating already has a trained AI model in the platform is determined (step 71). If there is no trained model associated with the user, training data is received from the user (step 72), such as images (including collections of images such as videos), audio files, and samples of text such as samples of the user writing. Unique features of the training data are extracted and the AI model is then trained using the unique features (step 73). If the training data includes one or more audio clips, the application layer can convert each clip to a spectrogram and then apply a fingerprinting algorithm (such as Mel-frequency cepstral coefficients (MFCC) or a constant-Q transform, though other fingerprinting techniques are also possible. If the training data includes one or more images, a perceptual hashing technique (such as pHash) or keypoint-based techniques (such as Scale-Invariant Feature Transform) may be used to generate a distinctive signature that includes the unique features. If the training data includes text, the unique features can be obtained using text-matching search and vector search, though other techniques are also possible. One or more DMI are generated using the trained model (74). Metadata for each DMI is created and associated with that DMI (step 75). The signature is created by identifying unique features of the DMI using the techniques described above, though other techniques are also possible. The metadata is created by combining an identification of the user with information creation with the DMI and user input regarding any usage restrictions for the DMI by other users.

Whether the created DMI are meant to be public or private is determined based on user input (step 76). If public (step 76), an NFT is minted for each DMI by associating that DMI with a unique identifier (step 77) and the unique identifier together with the metadata is recorded on one of the blockchain blocks of the blockchain layer (step 78). The signature of the DMI is generated (by extracting unique features from the DMI as described above) and stored together with the unique ID of the DMI are stored together in the similarity search database in association with the link to the DMI in the decentralized storage (step 79). In a further embodiment, the sequence of steps 78 and 79 can be reversed. A user is provided a confirmation (such as via email) of the created NFTs (step 80), including the unique identifier of those NFTs and the DMI (such as generated image, text, or audio) that are part of those NFTs, ending the routine 70.

If the DMI is designated as private by the user (step 76), the DMI is encrypted and stored as part of the application layer and outside of the blockchain layer (such as on the Static Assets Bucket Storage). A cryptographic hash of the DMI is generated and stored in a verification database that is in the blockchain layer and an NFT is minted by combining the hash with a unique identifier step 80 The hash can be created applying a cryptographic algorithm (such as SHA-256, though other algorithms can also be used) to the DMI. The created DMI is provided to the computing device of the requesting user (step 81, thus ending the routine 70. The created private DMIs are linked to the user who commissioned their creation by the records in that user's wallet.

Once an AI model is trained based on a user's identity (including voice, writing style, or image), the user can monetize that identity by making the trained AI model available to interested parties. FIG. 5 is a flow diagram showing a routine 90 for monetizing AI model for use in the method 20 of FIG. 2 in accordance with one embodiment. Pricing parameters for using the trained AI model are received by the platform from the user that is the owner of the trained IA model (step 91). Usage terms for DMI made using the AI model are received by the platform from the model owner (step 92). A selection is received by the platform from the AI model owner of whether the AI model owner would like to personally approve all requests for DMI generation using the trained model or if the user would like the application layer to automatically approve the requests by the usage terms. (step 93). The usage terms and the description of the identity based on which the AI model was trained are published by the application layer and the presentation layer on the marketplace for other users to see (step 94). Whether a bulk purchase (as opposed to on-demand purchase) of the DMIs generated using the trained model is requested is determined by the application layer (step 95). If bulk purchase is requested (step 96), a proposed rate for the bulk purchase is received from the buyer by the application layer. The proposed rate can be per batch of DMI (such as a certain price for 10000 generated using the trained model) or per a particular time during which the buyer can utilize the trained model. The content owner can either accept the proposed terms or present a counter offer (step 97). If agreement was reached between the buyer and the content owner (step 98), a smart contract is made by the application layer memorializing the term of the agreement and stored in the blockchain layer (step 99). If the agreement was not achieved and another offer from the buyer is received (step 100), the routine 90 returns to step 97. If no agreement was achieved (step 98) and no additional offers were received (step 99), the routine 90 ends.

Following the execution of the smart contract, payment from the buyer to the content owner is processed by the platform through using the third party payment system (step 101).

If no bulk purchase is desired by the buyer and instead the buyer wants to complete an on-demand purchase (step 95), the platform sets the price for each DMI to be generated based AI model owner's setting, and the routine moves 90 moves to step 101. When the step 101 is performed for on-demand purchase, the buyer simply pays in accordance with the set price per piece of generated content or on a per-word basis, depending on the pricing model established by the owner.

Following the successful completion of the payment, a content key for generating the DMIs is generated and provided to an API (step 102). A request from the buyer regarding the specific DMI to be generated, including description of the content of the DMI, is received by the platform (step 103). If automatic moderation is enabled (step 104), the platform analyzes the content description for the DMI to be generated, with the analysis including comparing the content description against usage restrictions imposed by the trained AI model owner (step 105). If based on the analysis the request is approved (step 106), the platform generates the requested DMIs using the trained AI model (step 107). The request is not approved (step 106), a rejection is sent by the platform to the buyer (step 108). If following the sending of the rejection at step 110 no additional requests are received (step 108), the routine 100 ends.

If automatic moderation is not enabled (step 104), the platform determines whether approval of the request for the generation of the DMI received in step 103 is approved by the owner of the trained AI model (step 110). If approval of the owner is received (step 110), the routine 90 moves to step 107 and the requested DMIs are generated. If the approval is not received within the required time period (step 110), the routine 110 moves to step 108 and a rejection notification is send, with the rejection notification optionally including feedback from the buyer.

Following the generation of the requested DMI, metadata is generated for each of the DMI and associated with the DMIs. The metadata can include the name of the buyer of the DMIs as well as the license (usage) conditions under which the DMIs were generated, as well as name and user ID of the user who is the owner (as well as a name and user ID of the user who is the licensor of the file used to make the DMI) of the DMI (though other metadata can also be included).

Following the generation of the DMI and the metadata, whether the requested are set as public or private is determined by the platform based on user input (step 112). If the DMIs are public (step 113), an NFT is minted for each DMI by assigning that NFT a unique ID (step 114). The signature for each of the public DMI is generated (by extracting unique features from the DMI as described above) stored in the similarity search database together with the identifier associated with the DMI (step 115). In a further embodiment, the sequence of steps 114 and 115 can be reversed. Record of the generation of the NFT as owned is recorded on one of the blocks of the blockchain layer, thus anchoring the detail of the transaction to a transparent, immutable, and unalterable record (step 116).

If the DMI is set to be private (step 112), a hash for the DMI is stored in the verification database in the blockchain layer (115). The method proceeds to recording the ownership of the buyer of the generated DMI (step 116), including in the wallet of the new owner, and providing the confirmation of the details of the transaction to the buyer and the trained AI model owner (step 117), ending the method 90.

The confirmation data received in step 117 can include any NFT transaction identifiers. This confirmation allows the owner to accumulate revenue from on-demand or bulk licenses, while the buyer gains verifiable rights to the newly generated content in accordance with the agreed-upon usage terms. The integrated moderation controls, which may be seamlessly switched between manual or AI-assisted review, ensure that the content owner retains oversight of their likeness or intellectual property, even at large transaction volumes.

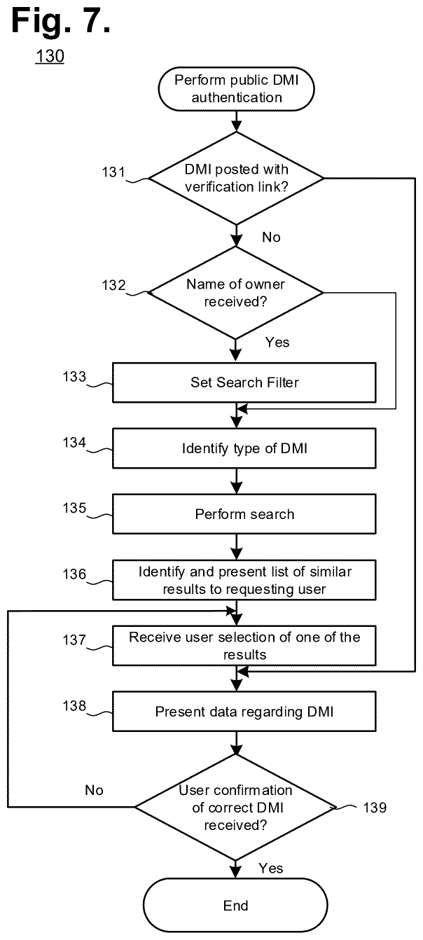

Upon encountering a DMI made in someone's likeness using AI, such as a voice snippet, photograph, or a written passage, a user of the platform may desire to be certain whether that particular DMI is authorized by the true owner of that likeness or is an unauthorized work made in violation of the owner's rights. FIG. 6 is a flow diagram showing a routine 120 for verifying authenticity of a DMI for use in the method 50 of FIG. 2 in accordance with one embodiment. A request for verifying authenticity of a particular DMI is received (step 121). Whether the DMI is public (such as available on publicly accessible Internet sites, including on the platform) or private (such as only available on the user's computer device and with the user being unwilling to publicly post the DMI) is determined based on user input (step 122). If the DMI is public (step 122), the platform performs public DMI authenticity verification as described below with reference to FIG. 7, ending the routine 120. If the DMI is private, the platform performs private DMI authenticity verification as described below with reference to FIG. 8, ending the routine 120.

Public DMI authentication can be the verification process in one of two ways: by selecting a verification link embedded in the DMI by the platform or by manually capturing or downloading the file for analysis by the platform. FIG. 7 is a flow diagram showing a subroutine 130 for public DMI verification for use in the routine 120 of FIG. 6 in accordance with one embodiment. Initially, whether the DMI in question is posted on the verification link is determined (step 131). Verification links are embedded in the DMIs generated by the platform, and if the DMI posted with the verification link (step 131), the platform retrieves data regarding the DMI by following with the link and presents the data to the user, such as by providing a preview of the DMI file, showing the info of the owner of the DMI, and showing an on-chain (on the block chain layer) proof of ownership, though still other data can also be displayed (step 138). If the DMI has no verification link (step 131), the platform determines whether the name of the owner of the DMI (such as a recognized artist or an AI model creator) has been received from the user (step 132). If the name of the owner has been received (step 132), the name is set as a filter on the search for the DMI (step 133). If the name of the DMI owner has not been received (step 132), the routine 130 moves to step 134 where the platform identifies the type of DMI in question, such as whether the DMI is an image file, an audio file, or a text file (step 134). One DMI can be of multiple types, such as a video that also includes an audio track. A search is performed by the platform for the DMI using the type of the DMI and if available, the owner's name. The search is performed by preparing the signature of the DMI in question by extracting unique features of the DMI (such as using techniques described above) and then comparing the signature to the signatures of the DMIs in the similarity search database (step 135). The techniques used to create the signature for the DMI whose authenticity is being verified must be the same as the technique used for creating the signatures of the DMI of the same type that are stored in the similarity search database. The search is done only among those of the signatures that are associated with the DMI designated as public. The search reveals the signatures that are closest to the signature of the DMI in question and consequently the DMI that are most similar to the DMI in question. A list of closest matches to the DMI whose authenticity is being verified is identified based on the search and is presented to the user (step 136). The number of matches presented can be predefined, with the matches having the greatest similarity being included. In a further embodiment, all matches meeting a predefined similarity threshold can be included on the list. A user selection of one of the matches is received (step 137) and data regarding the selection is presented to the user as described above (step 138). If user confirmation that the presented match is the correct match is received (step 139), the subroutine 130 ends. If the confirmation is not received (step 139), the method returns to step 137 where the user selects another match. If no match is found by the user, the user is provided a notification of no match being present.

In addition to verifying authenticity of publicly available DMIs, the system implements a file-based authenticity check that preserves the privacy of the underlying media file while ensuring accurate identification. FIG. 8 is a flow diagram showing a subroutine 140 for private DMI verification for use in the routine 120 of FIG. 6 in accordance with one embodiment. The private DMI file (such as an audio clip, image, or text document) that needs authenticated is received by the platform form the user (step 141). To protect the privacy and security of the received file, the platform does not store or broadcast the raw file data; instead, the platform computes a cryptographic hash by processing every bit of the file. A variety of cryptographic algorithms can be used for creating the hash, such as SHA-256, though other algorithms can also be used. This hashing step converts the file's binary data into a fixed-length, alphanumeric digest that uniquely identifies the file's contents. A search of for an exact match of the hash created in step 142 is performed among the hashes of the DMI stored in the verification database in the blockchain layer of the platform (step 143). This verification database is typically linked to the records in the blockchain layer or a secure off-chain repository that contains mappings of file hashes to registered non-fungible tokens (NFTs). If the match is found (step 144), the platform fetches the corresponding DMI record, which includes transaction history (such as the wallet address of the current owner and relevant timestamps), along with any additional metadata regarding the file's origin or licensing (step 145). The platform then presents this information to the user (step 146), providing on-chain proof that the content in question has been previously registered and is associated with a specific owner or creator, ending the subroutine (140).

If, on the other hand, the computed hash does not match any entry in the database, the system indicates that no prior registration exists for the uploaded file (step 147), ending the subroutine 140. The user is thus informed that the content is not recognized within the platform's records, and no further ownership claims can be verified at this time.

This hash-based verification approach is pivotal for private media because the approach does not require exposing the file's contents to the public or storing them unencrypted. By limiting disclosure to the hash value, the platform maintains user confidentiality while still leveraging the deterministic and tamper-evident properties of cryptographic hashing. Additionally, the use of an exact-match database-rather than a similarity-based or partial match approach-ensures that only identical files can be matched, reducing the potential for false positives and guaranteeing that the verified content is precisely the one registered on the blockchain layer.

In addition to providing a way to lawfully reproduce, monetize, and authenticate digital media, the platform also allows to implement an influencer-powered marketplace that offers a multi-tier commission structure within a social media-style user experience. FIG. 9 is a flow diagram showing a routine for performing product price regulation based on influencer input for use in the method 50 of FIG. 2 in accordance with one embodiment. An identification of a new product (which can be one of the DMI or a physical product) proposed for sale on the platform is received from a user that is the seller of the product (step 151). A description of a campaign that specifies the commission rates applicable to influencers at various performance levels for promoting the product is received from the seller (step 152). Applications to join the campaign are received from other users of the platform who are influencers interested in promoting the product (step 153). The platform admits the influencers that applied to the campaign and evaluates metrics such as follower count, engagement, and prior sales of the influencers that applied to determine those influencers' level (step 154). A commission is set for the influencers based on their level and the description of the campaign (step 155) and optionally, a discount is set for the product for followers of an influencer based on the influencer's input and commission level (step 156). In particular, an influencer can choose to share part of their commission as a discount for their followers, thereby offering a lower price than might otherwise be publicly available. This mechanism not only incentivizes buyers but also distinguishes the platform from traditional drop-shipping or affiliate models, where influencers might artificially inflate prices to maximize profit. Instead, the discount-based approach fosters greater trust and loyalty: buyers receive a competitive price directly from their favorite influencer, and sellers benefit from higher conversion rates driven by the influencer's authentic endorsement.

If the seller accepts the discount on the product set for the influencer's followers (step 157, then proceeds of the sale of the product via the platform are distributed based on the sales, the discount, the influencers' commission, ending the routine 150 (step 158). If the seller does not accept the discount (step 157), the routine 150 ends.

As mentioned above, the sharing of the discount for the product builds the trust between the influencers and the followers. This trust through a social media-style feed, where influencers post genuine content-such as reviews, videos, and personal experiences-showcasing how the product fits into their lifestyle. This dynamic replaces the static, impersonal product page often found on other platforms, allowing buyers to engage in a more natural, community-driven environment. When a purchase occurs, the transaction is automatically apportioned so that:
1. The buyer benefits from the influencer's shared discount.
2. The seller receives the agreed-upon base price.
3. The influencer earns a commission tied to the campaign settings and their assigned level.

If the seller declines an influencer's application at any stage, the system notifies the influencer accordingly, preserving transparency and consistency. By blending authentic social engagement with a flexible commission-sharing structure, the platform establishes an ecosystem in which sellers gain highly targeted promotional reach, influencers can cultivate deeper relationships with their followers, and buyers enjoy competitively priced products backed by credible endorsements.

In one embodiment, the influencer level determined in step 154 can be determined in accordance to a metric referred to as Word of Mouth Power (WOMP), which provides sellers a quantifiable and comparative means of assessing influencer effectiveness.

$$WOMP = \frac{\sqrt{E \times C} \times IL \times SL}{100}$$

Where:
E: Engagement Rate (expressed as a percentage)=(Real clicks/Total Fan Base)*100
C: Conversion Rate (expressed as a percentage)=(Real Buyers/Total clicks)*100
IL: Influence Level, ranging from 1 to 10.
SL: Sales Level, ranging from 1 to 10.

By combining these four variables, WOMP produces a single, standardized metric that incorporates both quantitative measures of engagement and conversion (E and C) alongside qualitative and historical factors (IL and SL). This integrated approach is particularly advantageous for sellers, as it allows them to:
Identify High-Performing Influencers: A higher WOMP value generally indicates that the influencer not only commands a large or attentive audience, but also excels at converting that audience into actual buyers.
Compare Influencers Across Multiple Campaigns: Because WOMP encapsulates performance over time, sellers can make cross-campaign and cross-product comparisons, mitigating short-term anomalies or influencer-specific biases.
Reward Sustainable Success: The formula's inclusion of IL and SL ensures that sustained performance and consistent sales results are reflected, rather than relying on transient spikes in engagement or singular viral events.
Encourage Genuine Promotion: By emphasizing real clicks and genuine buyers, WOMP discourages superficial metrics such as follower inflation, thereby ensuring that influencer rankings mirror authentic impact.

The platform can update each component (E, C, IL, SL) of WOMP as new data becomes available-such as additional clicks, conversions, and user feedback-so that WOMP remains current. Once calculated, the platform displays WOMP to sellers, who can then prioritize or offer higher commission tiers to influencers with superior scores. Conversely, influencers seeking to increase their WOMP must elevate real engagement, focus on audience conversion, and maintain positive sales momentum over multiple campaigns.

By structuring these performance variables into a single, easy-to-interpret figure, WOMP addresses a critical gap in conventional influencer marketplaces, where sellers often lack a unified metric beyond mere follower counts or like-based statistics. Instead, the invention ensures that all relevant elements of influencer performance are captured, facilitating a clear and equitable framework for identifying, rewarding, and collaborating with the most impactful influencers.

The system and method described above can be used in a variety of ways. A few examples, given for purposes of illustration and not limitation, are provided below. These examples collectively illustrate how the invention's multi-layered integration of AI content generation, signature extraction, blockchain-based verification, influencer marketing, and automated licensing can address a wide range of industry-specific needs. The system and method provide secure ecosystem that offers transparency, trust, and scalability in digital content production, distribution, and monetization.

### Social Media Identity Verification

In one use case, a social media influencer registers their likeness (voice and image) through on the platform. The platform prompts the influencer to supply short video clips, photographs, and voice samples. Each sample is processed into either a perceptual or keypoint-based hash for images, or a spectrogram hash for audio.

Once linked to the influencer's on-chain record, any newly generated AI-based content purporting to use the influencer's likeness can be subjected to a verification search. If a third party attempts to circulate a deepfake video, the platform computes a hash of the suspect file and queries the blockchain ledger. If the file does not match the influencer's registered signatures, the platform notifies relevant stakeholders that the content may be unauthorized. In this manner, social media platforms are able to protect public figures from unauthorized clones, while providing a transparent, immutable record of genuine AI-generated works.

### Influencer Marketing and E-Commerce

In a further example, the system and method described facilitate a promotional campaign in which an influencer agrees to advertise a new product on the platform's marketplace. The platform dynamically assigns a commission tier to the influencer based on a Word of Mouth Power (WOMP) score. The influencer subsequently lists a review video under a social media-style feed, demonstrating the product's features and offering a portion of their commission as a discount to viewers who purchase via their post.

When a viewer clicks through and completes a purchase, the platform automatically mints or updates an on-chain record documenting the sale, calculates the influencer's commission, and debits the buyer's account for the discounted product price. The influencer's WOMP score is then recalculated to reflect the new engagements and conversions, potentially elevating the influencer's commission tier for future campaigns. This workflow demonstrates how components such as discount-based marketing and affiliate tracking are integrated with the platform's commission structuring, AI-driven content moderation, and NFT-based recordkeeping.

### Large-Scale Corporate Licensing

In yet another example, a media enterprise negotiates a bulk contract to use a popular voice model for a series of advertisements. The enterprise and the voice owner leverage the platform's smart contract licensing service, specifying a discounted rate for generating a minimum of fifty voice clips over a defined campaign period. Once the contract is executed on-chain, each advertising script is automatically moderated according to the voice owner's guidelines (e.g., prohibitions on explicit content or conflicting endorsements). Upon each approved script, an AI-generated voice clip is produced and registered on the blockchain as a distinct NFT, subject to the bulk licensing terms.

This mechanism allows the voice owner to retain precise control over how their likeness is deployed at scale, while the media enterprise benefits from automated licensing and instantaneous royalty distributions. If the enterprise's usage surpasses the minimum threshold, the smart contract automatically applies a negotiated discount rate and updates the distribution logic accordingly, without manual intervention.

### Unauthorized Deepfake Detection

The system and method described also address emerging challenges posed by deepfake technology. An organization may periodically sample viral videos on social media platforms, extracting their audio and video signatures. The organization can then compare these signatures against a ledger of known authorized files from registered celebrities or public figures using the platform. If a match or partial match is found, the platform checks whether a valid on-chain registration exists for the suspicious file. In the absence of a valid record, the platform flags the file as potentially unauthorized content. By integrating audio-visual fingerprinting techniques with the blockchain-based ownership database, the system and method offer a powerful tool for early detection and prevention of deepfake misuse. Thus, the system and method described allow to differentiate between AI-generated works that are lawful (generated by an authorized party, who is either the owner of the rights to the likeness used to generate the work or a licensee of that owner) from illegal derivations that are made without consent of the person whose likeness (such as image, voice, or writing style) are being exploited.

While the invention has been particularly shown and described as referenced to the embodiments thereof, those skilled in the art will understand that the foregoing and other changes in form and detail may be made therein without departing from the spirit and scope of the invention.

1. A cloud-based system for generating and utilizing media using artificial intelligence, comprising:
a platform in a cloud-computing environment and comprising a plurality of layers, each of the layers implemented by one or more servers, the layers comprising:
a presentation layer configured to receive from a computing device of a user over an Internetwork training data for generating media;
a blockchain layer comprising a blockchain storage; and
an application layer configured to:
train an artificial intelligence model using the training data and to generate one or more digital media items using the trained model;
generate a non-fungible token (NFT) associated with each digital media item, wherein metadata of the digital media item is linked to the NFT;
generate a file pattern for each of the generated digital media items;
store the file pattern associated with each of the generated digital media items in a database comprised in the platform;
generate the metadata associated with each of the digital media items and store the metadata in the database in association with the file pattern for that digital media item;
receive user input to mark one or more of the digital media items as private;
encrypt the private digital media items;
store the encrypted private digital media items and the metadata associated those encrypted private digital media items outside of the blockchain storage, wherein the file pattern for each of the encrypted private digital media item comprises a cryptographic hash of that encrypted digital media item;
link the hash for each encrypted private digital media item to a unique identifier in the block chain layer, wherein the NFT for that encrypted private digital media item is created by the linking;
store the hash with the unique identifier in the blockchain storage;
use one or more of the file patterns for comparison of one or more further digital media items to the digital media items associated with those file patterns; and
take an action on the one or more further digital media items based on the comparison.

2. A system according to claim 1, wherein one of the digital media items is an audio data item, the file pattern for that audio data item comprises a signature, and generating the signature of the audio data item comprises converting the audio data item to a spectrogram and applying a fingerprinting algorithm to extract one or more features from the spectrogram, wherein the file pattern for the audio data item comprises the extracted features.

3. A system according to claim 1, wherein at least one of: one of the digital media items comprises an image, the file pattern for the image comprises a signature, and generating the signature of the one digital data item comprises applying at least one of a perceptual hashing technique and a keypoint-based technique to the image; and one of the digital data items comprises text and generating the file pattern of the one digital data item comprises applying at least one of a text-matching search and a vector search to the text.

4. (canceled)

5. A system according to claim 1, further comprising:
the application layer further configured to receive user input for making one or more of the digital data items public and generate an identifier for each of the one or more of the public digital media items and store the one or more digital media items in association with the identifier in the blockchain storage.

6. (canceled)

7. A system according to claim 1, wherein the metadata comprises an identification of the user and terms under which the digital media item identified by the metadata can be licensed.

8. A system according to claim 7, wherein the terms comprise pricing parameters, usage restriction, and a preferred approval technique for approving parameters of additional digital media items.

9. A system according to claim 8, the application layer further configured to execute a smart contract for creation of one or more of the additional digital media items using the trained artificial intelligence model based on the licensing parameters and to store the smart contract in a further layer different from the application layer and the presentation layer.

10. A system according to claim 8, wherein the smart contract is for at least one of on-demand generation of the additional digital media items and in-bulk generation of the additional media items.

11. A system according to claim 8, the application layer further configured to process payment in accordance with the smart contract.

12. A system according to claim 8, wherein the preferred approval technique comprises automated approval of the additional media item parameters by the application layer based on content parameters received from the user.

13. A system according to claim 8, wherein the preferred approval technique comprises approval of the application content parameters based on input from the user.

14. A system according to claim 1, the platform further configured to receive a request from a further user to treat the further digital media items as private and to generate hashes of the additional digital media items, wherein the comparison comprises comparing the hashes to the file patterns of the digital media items.

15. A system according to claim 14, wherein the platform does not store the private further digital media items.

16. A system according to claim 1, wherein the file pattern for one or more of the digital media items comprises a signature that comprises a set of unique features for that digital media item, wherein the comparison comprises comparing signatures of the further digital media items to the signatures of the one or more digital media items.

17. A system according to claim 1, wherein the action comprises verifying an authenticity and registration status of the further digital media items and outputting a result of the verification to a requesting user through the presentation layer.

18. A system according to claim 1, wherein the application layer is interfaced to the presentation layer via an application programming interface gateway comprised in the application layer.

19. A system according to claim 1, the platform further configured to:
receive from the computing device of the user a commission structure for influencers for promoting one or more of the digital media items; and
admit one or more of the influencers for promoting the one or more digital media data items based on an evaluation.

20. A system according to claim 19, the platform further configured to:
calculate a level of the admitted influencers;
receive from the user a price at which one or more of the digital media items can be purchased by one or more further users;
adjust the price for one or more of the further users based on input from one or more of the admitted influencers associated with those further users and the level of those influencers; and
allocate a portion of the price paid by those further users to at least one of the influencers associated with those further users in accordance with the commission rate structure.

21. A cloud-based system for generation and term-based utilization of media using artificial intelligence, comprising:
a platform in a cloud-computing environment and comprising a plurality of layers, each of the layers implemented by one or more servers, the layers comprising:
a presentation layer configured to receive from a computing device of a user over an Internetwork training data for generating media; and
an application layer configured to:
train an artificial intelligence model using the training data and to generate one or more digital media items using the trained model;
generate a non-fungible token (NFT) associated with each digital media item, wherein metadata of the digital media item is linked to the NFT, wherein the metadata comprises an identification of the user and terms under which the digital media item identified by the metadata can be licensed, and wherein the terms comprise pricing parameters, usage restriction, and a preferred approval technique for approving parameters of additional digital media items;
generate a file pattern for each of the generated digital media items;
store the file pattern associated with each of the generated digital media items in a database comprised in the platform;
generate the metadata associated with each of the digital media items and store the metadata in the database in association with the file pattern for that digital media item;
use one or more of the file patterns for comparison of one or more further digital media items to the digital media items associated with those file patterns; and
take an action on the one or more further digital media items based on the comparison.

22. A cloud-based system for generating and selling media using artificial intelligence, comprising:
a platform in a cloud-computing environment and comprising a plurality of layers, each of the layers implemented by one or more servers, the layers comprising:
a presentation layer configured to receive from a computing device of a user over an Internetwork training data for generating media; and
an application layer configured to:
train an artificial intelligence model using the training data and to generate one or more digital media items using the trained model;
generate a non-fungible token (NFT) associated with each digital media item, wherein metadata of the digital media item is linked to the NFT;
generate a file pattern for each of the generated digital media items;
store the file pattern associated with each of the generated digital media items in a database comprised in the platform;
use one or more of the file patterns for comparison of one or more further digital media items to the digital media items associated with those file patterns; and
take an action on the one or more further digital media items based on the comparison; and
a presentation layer configured to:
receive from the computing device of the user a commission structure for influencers for promoting one or more of the digital media items;
admit one or more of the influencers for promoting the one or more digital media data items based on an evaluation;
calculate a level of the admitted influencers;
receive from the user a price at which one or more of the digital media items can be purchased by one or more further users;
adjust the price for one or more of the further users based on input from one or more of the admitted influencers associated with those further users and the level of those influencers; and
allocate a portion of the price paid by those further users to at least one of the influencers associated with those further users in accordance with the commission rate structure.
